(19) United States
(12) Patent Application Publication
(10) Pub. No.: US 2008/0149558 A1
(43) Pub. Date: Jun. 26, 2008

(54) Centrifuge drum

(75) Inventors: Sandro M.O.L. Schneider, Thalwil (CH); Gernot Busch, Effingen (CH); Roland Kuenzli, Mellingen (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ferrum AG, Rupperswil (CH)

(21) Appl. No.: 12/002,652

(22) Filed: Dec. 17, 2007

(30) Foreign Application Priority Data
Dec. 21, 2006 (EP) 06126769.6

(51) Int. Cl. B01D 33/067

(52) U.S. Cl. 210/380.3; 210/380.1

(57) ABSTRACT

The invention relates to a centrifuge drum (1) for a centrifuge for the separation of a mixture into a solid material cake and into a liquid phase, including a drum lid (2) forming the centrifuge drum (1), a drum base and a drum jacket (3), wherein the drum jacket (3) extends along a longitudinal axis (4) of the centrifuge drum (1) and the drum lid (2) and the drum base are arranged on the drum jacket (3) perpendicular to the longitudinal axis (4) and opposite to one another. In this arrangement the centrifuge drum (1) is rotatably arranged about the longitudinal axis (4) in the centrifuge in the installed state and is rotatable in the operating state at a predeterminable speed of rotation about the longitudinal axis (4) by means of a drive and a filter medium (6) is provided at an inner peripheral surface (5) of the centrifuge drum. An attachment device (7) is provided at the inner peripheral surface (5) of the centrifuge drum, at least section-wise for the fixing of the filter medium (6). In accordance with the invention the attachment device (7) has the form of an attachment web (7, 71) protruding radially into the centrifuge drum (1) in the direction towards the longitudinal axis (4) of the centrifuge drum (1) and extends on the inner peripheral surface (5) along a peripheral direction (8) of the centrifuge drum (1) around the longitudinal axis (4). The invention further relates to a centrifuge with a centrifuge drum in accordance with the invention.

The invention relates to a centrifuge drum in accordance with the pre-characterising part of the independent claim 1.

Centrifuges in the most diverse embodiments are widely used for the drying of moist substances or moist mixtures of substances and are used in the most diverse fields. Thus, for example discontinuously operating centrifuges, such as sliding discharge centrifuges are preferably used in which, after the successful separation of a mixture into a solid material cake and a liquid phase, the solid material cake is peeled off the drum wall by means of a peeling device and is carried out of the drum to the outside via suitable devices, for example via a slide. In other discontinuous systems, preferably however only in centrifuges on a laboratory scale, it can be the case that no automatic peeling apparatus is present but rather that the centrifuge is stopped after separation of the mixture has taken place and the deposited solid material cake is removed from the drum manually.

In particular, when large amounts of a solid-liquid mixture are to be separated continuously, continually operating pusher centrifuges are used to advantage. In this connection one stage or multi-stage pusher centrifuges and also so-called double pusher centrifuges are used, depending on the requirement.

All of these centrifuges have been well-known to the person averagely skilled in the art for a long time and are described in detail in the standard work “Industry Centrifuges” by Professor W. Stahl, DrM PRESS for example.

The centrifuge drum itself is as a rule designed as a hollow cylindrical basket which has a plurality of drain apertures in its peripheral surface through which the centrifuged off liquid phase is drained out of the centrifuge drum to the outside. I.e. the drum of filter centrifuges is drilled in regular patterns, for example at spacings of a few centimetres in order to release the filtrate, in other words the liquid phase, through the drum jacket.

In this arrangement the inner peripheral surface of the centrifuge drum is often lined with an additional filter medium, for example a filter cloth, onto which the solid material cake sediments during the centrifuging process.

In this arrangement the filter medium initiates the cake formation in the suspension by its barrier effect relative to the solid material flowing towards it. In this connection attention must be paid in particular that the filter medium is not only secured against possible peripheral displacements since, for example during the filling process or during the peeling operation, tangential acceleration forces or cutting forces can arise. A security against axial displacements is also provided, so that the filter cloth is also reliably secured against displacements along the axis of rotation of the centrifuge drum.

In order to guarantee this numerous solutions are known in the prior art which one likewise finds listed and described in the previously cited work by Professor Stahl.

Thus, for example in peeler centrifuges, the filter cloth is placed as material sold by the meter on a supporting tissue and was laid in two parts with half the circumference and a respective overlap in such a way that the incoming suspension can not enter between the two cloth halves, in other words the cloth lying on top points away from the running direction.

A disadvantage of this solution is to be found above all in the fact that a double filter cloth resistance arises at the overlap which can lead to a reduced cake thickness at these points of overlap. In the same way the demoistening deteriorates at these points. Moreover, a symmetrical embodiment of the overlap is necessary in order to avoid imbalance arising at the join.

A substantial improvement with respect to the overlapping cloths is displayed by the endless filter cloths in cylinder shape which additionally offer a certain comfort i.e. in particular a simplification for assembly and dismantling. Moreover, they substantially mitigate the problems of the overlapping filter cloths, above all for critical filtrations.

Cylinder shaped filter cloths such as these, but also open filter cloths have hitherto been fixed in a channel or groove at both ends of the drum, the channels or grooves being milled into the drum jacket in the circumferential direction, for example after manufacture of the drum.

The filter medium in other words the filter cloth for example is folded over into the, for example, dovetail-like previously mentioned peripherally extending narrow channels or grooves near the front or rear side of the centrifuge drum and the free excess length of the filter cloth is simply cut off after this. To attach it the filter cloth is clamped into the narrow channel or groove by means of a string of fine chrome nickel steels or a round cord of rubber, for example with a solid circular diameter.

This kind of attachment is unsatisfactory for different reasons. The dovetail groove at the transition points into the front circular ring disc or into the rear full disc of the drum is extremely unsatisfactory as regards its strength. Exchanging the cloth requires experienced staff, in particular in order not to damage the cloth when caulking it in place and the down times necessary while the cloth is exchanged are unjustifiably long.

A certain improvement is brought about by inflatable seals, which are used in place of the string or cord which is to be caulked into place and which permit a fast assembly and dismantling of the filter medium. The drum is provided with a dovetail shaped indent at both ends into which the inflatable sealing rings are inserted.

Another known method is the attachment of the filter cloth in a channel or groove by means of a quick clamping ring.

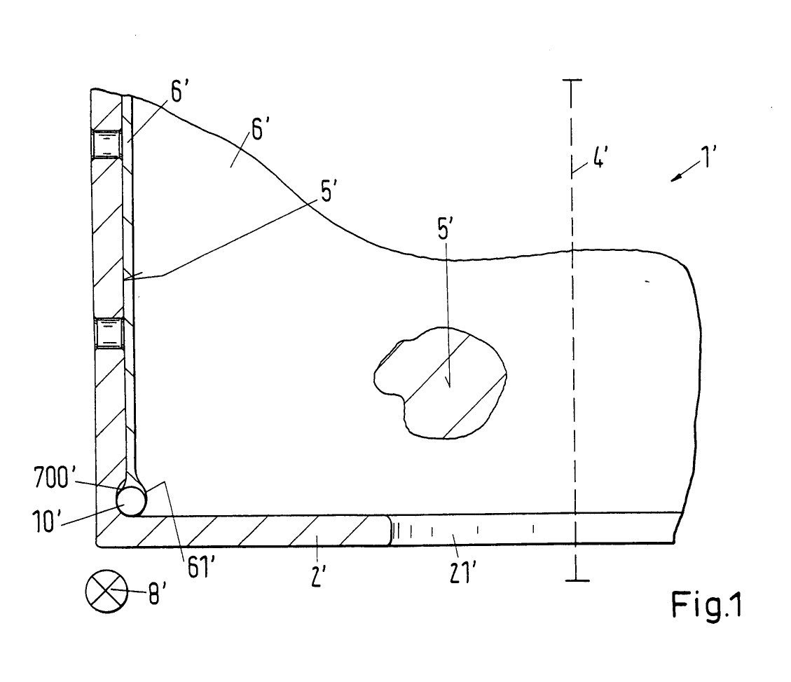

To explain this attachment method reference is made in the following to the schematic drawings of FIG. 1 to FIG. 3d with the help of which the previously described prior art will be described in more detail. To distinguish the prior art from the present invention the reference numerals which relate to features of known embodiments are provided with an apostrophe while features of embodiments in accordance with the invention are provided with reference numerals which have no apostrophe.

By way of example a centrifuge drum 1′ known from the prior art is schematically illustrated by FIG. 1, in which a filter cloth 6′ is attached by means of a clamping ring 10′ in a groove 700′ milled into the centrifuge drum 1′ in the peripheral direction 8′ by means of a clamping ring 10′. In well-known manner the centrifuge drum 1′ includes a drum jacket 3′ forming the centrifuge drum 1′ and a drum lid 2′, through which, for example through the aperture 21′, a suspension to be de-moisturised can be introduced. In addition, the known centrifuge drum 1′ is formed by a drum base 200′, not illustrated in FIG. 1 for reasons of clarity, which is coupled to a likewise not illustrated rotary drive to drive the centrifuge drum 1′. The drum jacket 3′ extends in the manner of a cylinder along the longitudinal axis 4′ of the centrifuge drum 1′ and the drum lid 2′ and the drum base 200′ are arranged perpendicular to the longitudinal axis 4′ lying diametrically opposed at the drum jacket 3′ and thus form the two end surfaces of the cylindrical centrifuge drum 1′.

A filter medium 6′, in the present case a textile filter cloth 6′ is provided at an inner peripheral surface 5′ of the centrifuge drum 1′, with a groove 700′ in which the filter cloth 6′ is fixed by means of the clamping ring 10′ being provided for fixing the textile filter cloth 6′ at the inner peripheral surface 5′ of the centrifuge drum 1′.

In addition, related to the axial longitudinal direction 4′, a peripheral hemstitched seam 61′ is provided at both ends of the filter cloth 6′ into which the clamping ring 10′ is introduced prior to the installation of the filter cloth 6′ in the centrifuge drum 1′.

Then the filter cloth 6′ is placed on the inner peripheral surface 5′ of the centrifuge drum 1′, the hemstitched seam 61′ with the clamping ring 10′ is laid into the groove 700′ and the clamping ring 10′ is clamped by means of a quick clamping device 101′, for example, so that the filter cloth 6′ is fixed securely in the centrifuge drum 1′.

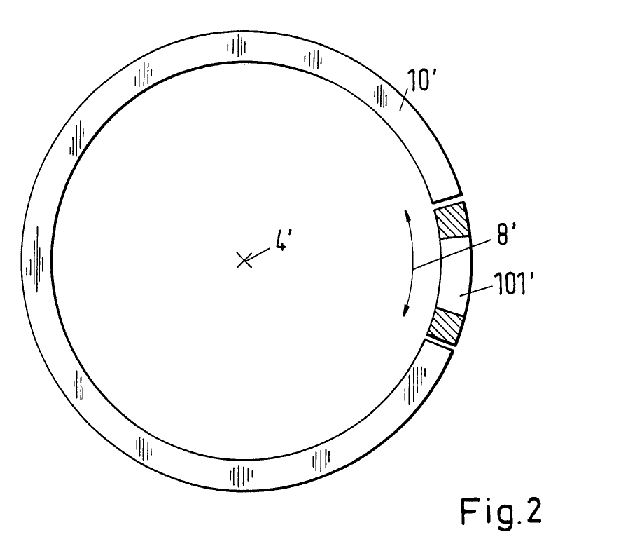

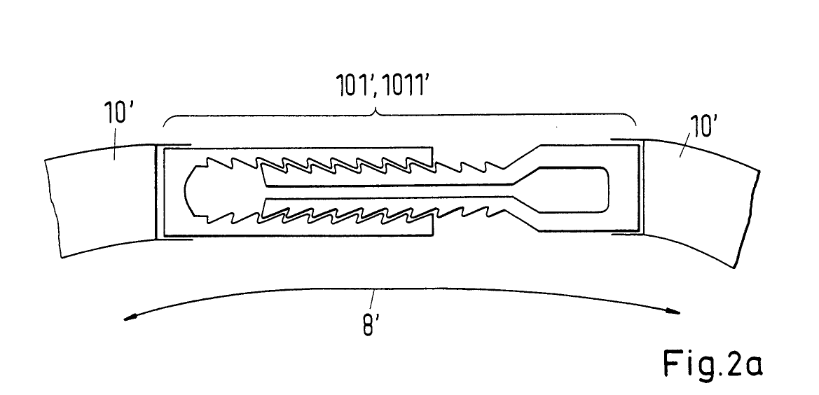

A clamping ring 10′ of this kind is illustrated in FIG. 2 which, in the operating state, lies concentrically to the axial direction of the longitudinal axis 4′ of the centrifuge drum 1′, which is not illustrated in FIG. 2. The clamping ring 10′ preferably has a clamping device 101′ which makes it, possible, for example via a known screw thread mechanism, to increase the periphery of the clamping ring 10′ in the groove 700′, whereby to jam the clamping ring 10′ in the groove 700′, by which means the filter cloth 6′ is securely fixed in the centrifuge drum 1′.

In this connection a whole series of quick clamping devices of diverse form is known, which can be used as expedient.

Clamping devices 101′ are particularly simple to operate which, for example, have a ratchet 1011′ in which for example two serrated surfaces engage into one another, and which can be displaced relative to each other in such a way that the size of the clamping ring 10′ can be enlarged, with the two serrated surfaces hooking into each other so that the larger circumference and the clamping force or contact pressure thereby produced in the groove 700′ is automatically maintained. Quick clamping devices 101′ of this kind are also well known in other technological fields. As an illustration a special embodiment of a quick clamping device 101′ of this kind is shown in FIG. 2a.

In this connection, in the prior art, different embodiments of grooves 700′ extending in the peripheral direction 8′ can also be distinguished, which are executed differently, depending on the requirement or depending on the actual nature of the fixing of the filter cloth 6′, or can be provided in different regions in the centrifuge drum 1′.

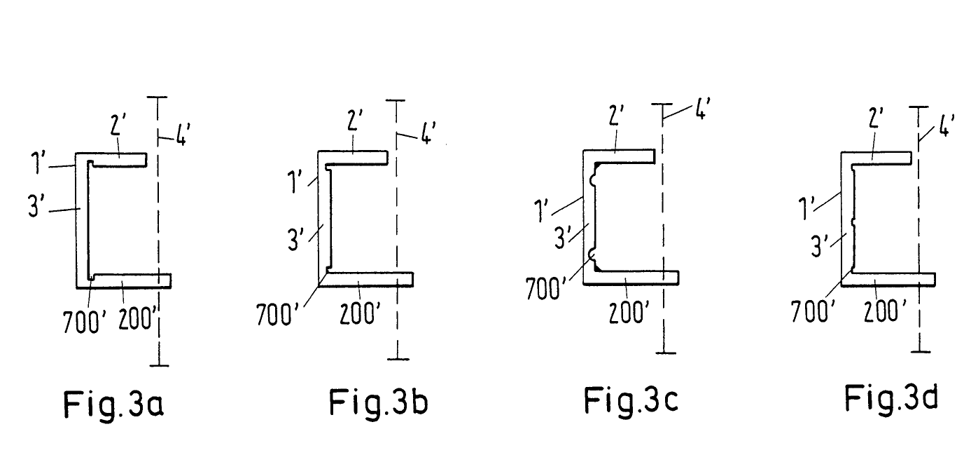

A selection of different known types of groove 700′ is illustrated schematically in FIGS. 3a to 3d.

FIG. 3a and FIG. 3b show grooves 700′, which in FIG. 3a are provided in the drum lid 2′ or in the drum base 200′ and in the example of FIG. 3b are milled in the inner peripheral surface 5 of the drum jacket 3′. The groove configurations in accordance with FIG. 3a and FIG. 3b are preferably used when the filter cloth 6′ is pressed into the groove by means of a string or a cord as described further above.

FIG. 3c and FIG. 3d show groove configurations with grooves 700′ for example which are preferably selected when, for example, one of the above described clamping ring techniques is used for the fixing of the filter cloth 6′ by means of a clamping ring 10′ in the centrifuge drum 1′.

However, different as the previously described attachment methods and attachment devices for the attachment of a filter medium in a centrifuge drum may be, they are all linked by a common problem, which arises in the use of a groove for the attachment of the filter medium, in other words of the filter cloth for example.

The use of a groove is, namely associated with a whole series of disadvantages which are more or less serious, depending on the special application.

One of the most significant disadvantages is due to the fact that after the welding of the drum as such, in other words after the welding of the drum base and the drum lid to the drum jacket, the groove for the attaching of the filter cloth has to be incorporated into the drum lid and/or into the drum base and/or into the drum jacket, in other words has, for example, to be milled into these.

In terms of production engineering this is not only very complex, i.e. complicated and thus correspondingly expensive and uneconomical, but above all the milling and/or turning of groove such as this naturally weakens the mechanical stability of the entire drum since material is removed from the drum body though the grooves, which is no longer available to preserve the stability of the drum and/or as a result of which, in the worst case scenario, predetermined breaking points are defined in the centrifuge drum, which, under certain operating conditions in which the centrifuge drum is severely loaded, can lead to cracks or even breaks in the centrifuge drum, i.e. mechanical stresses in the material of the drum can arise and a distortion of the material could even result so that the rotational symmetry of the centrifuge drum is badly distorted, which leads to a higher cost and complexity in the subsequent balancing operation.

Moreover, during the machining of the groove in the centrifuge drum, mechanical stresses can arise in the material of the drum, or even material deformation can take place, so that the rotational symmetry of the centrifuge drum is severely disturbed, which can lead to imbalance in operation, so that a centrifuge drum of this kind could become unserviceable through the introduction of the groove.

A further considerable disadvantage occurs during the processing of ultra-pure products in which the highest hygiene standards have to be maintained, for example in the processing of ultra-pure pharmaceutical products in which the drum has to be cleaned often, in the worst case after each charge that is processed. The correct cleaning of the groove in which the filter cloth is fixed is particularly problematic in this arrangement because the grooves are difficult to reach for the cleaning operation and, depending on the specific geometry, can often not be cleaned completely to the required degree of cleanliness.

It is therefore the object of the invention to propose an improved centrifuge drum in which a filter medium, in particular a textile filter cloth, can be installed or replaced in the centrifuge drum particularly simply, quickly and reliably, wherein the centrifuge drum has the highest possible mechanical stability and simultaneously can be cleaned simply and most effectively, even in accordance with the highest standards of hygiene, so that the disadvantages known from the prior art can be avoided to a large extent.

The subject matter of the invention satisfying these objects are characterised by the features of the independent claim 1.

The dependent claims relate to particularly advantageous embodiments of the invention.

The invention thus relates to a centrifuge drum for a centrifuge for the separation of a mixture into a solid material cake and a liquid phase, including a drum lid forming the centrifuge drum, a drum base and a drum jacket, wherein the drum jacket extends along a longitudinal axis of the centrifuge drum and the drum lid and the drum base are arranged perpendicular to the longitudinal axis and lying diametrically opposed at the drum jacket. In this connection the centrifugal drum is rotatably arranged about the longitudinal axis in the centrifuge in the installed state, is rotatable in the operating state by means of a drive with pre-determinable speed of rotation about the longitudinal axis and a filter medium is provided at the inner peripheral surface of the centrifuge drum, with an attachment device being provided at the inner peripheral surface of the centrifuge drum at least section-wise. In accordance with the invention the attachment device has the form of an attachment web protruding radially into the centrifuge drum in the direction towards the longitudinal axis of the centrifuge drum and extends on the inner peripheral surface along a peripheral direction of the centrifuge drum around the longitudinal axis.

The advantages of the centrifuge drum in accordance with the invention are evident.

Due to the fact that the machining of a groove for the attachment of the filter medium, in other words of a filter cloth for example, into the drum lid and/or the drum base and/or the drum jacket is dispensed with, the manufacture of the centrifuge drum is considerably simplified. It is thus more economical than the manufacture of the centrifuge drum known from the prior art with a milled in groove for the attachment of the filter cloth. Furthermore, the centrifuge drum in accordance with the invention is mechanically much more stable because the milling out of the groove is dispensed with, and thus no material has to be machined out of the centrifuge drum, which would lead to mechanical weakening of the material at the corresponding points or regions in the known centrifuge drum.

Moreover, the centrifuge drum in accordance with the invention can be cleaned much more simply and reliably which plays a decisive role in the processing of highly sensitive and ultra-pure products on which the highest standards of hygiene are placed in particular, such as for example but not only in the processing of ultra-pure pharmaceutical products.

The attachment devices in the form of attachment webs in accordance with the present invention are moreover simple to attach in the centrifuge drum on or at an inner peripheral surface on the drum lid and/or on the drum base and/or on the drum jacket. Even older centrifuge drums which are already in operation, for example those with attachment grooves such as those described in detail with the help of FIG. 1 to FIG. 3d at the beginning of this specification, can be converted simply to a centrifuge drum in accordance with the invention. This can be done, for example, in that attachment webs are welded in at a later date or installed in the centrifuge drum in another manner. This is a particularly interesting variant when, for example, pollution in the groove plays a subordinate role, for example because no excessively great hygiene or purity demands are made on the products to be processed.

Thus, it is, for example, possible to convert a centrifuge drum of the type in accordance with FIG. 3a or FIG. 3b, which are only suitable for filter cloths which are pressed into a groove by means of a string or a cord as described above, in such a way that filter cloths with clamping rings can also be used, by simply retrospectively installing attachment webs in accordance with the present invention into the centrifuge drum.

A conversion of an existing centrifuge drum from the prior art to a centrifuge drum in accordance with the invention can be worthwhile in different cases, for example because the attachment of the filter medium in a centrifuge drum in accordance with the invention is far simpler, far faster and less susceptible to errors, so that in particular when frequent filter cloth changes are necessary, a conversion to a centrifuge drum in accordance with the invention is worthwhile for these reasons alone.

As a particularly important advantage of the invention it is to be stressed that a conversion of a centrifuge drum known from the prior art can also be carried out at the customer's premises and, what is more, even without having to dismantle the centrifuge drum out of the centrifuge for the conversion to a type in accordance with the invention. This means that an older centrifuge drum can be comfortably retrospectively converted in the installed state in the centrifuge at the customer's premises.

In a preferred embodiment the attachment device extends along the peripheral direction at a pre-determinable spacing from the drum base in such a manner that a first annular attachment space extending in the peripheral direction is formed between the drum lid and the attachment device for the attachment of the filter medium.

The attachment device can preferably, but not necessarily, simultaneously or alternatively extend in the peripheral direction at a predeterminable spacing from the drum lid so that a second annular attachment space extending in the peripheral direction is also formed between the drum lid and the attachment device, or is formed between the drum lid and the attachment device.

This means, in relation to the axial direction, that an attachment web is preferably provided at both ends of the centrifuge drum with respect to the axial direction in such a manner that, for example, a filter cloth can be fixed in the first or second attachment space with a clamping ring or an integrated attachment ring.

In a special case a plurality of attachment webs is provided in this arrangement which are preferably formed as blocking pins. This means that a plurality of blocking pins is provided in the peripheral direction as fixing webs which are arranged in the inside of the centrifuge drum in the peripheral direction, for example on the drum lid and/or on the drum base and/or on the drum jacket, preferably at the same spacing, in such a manner that the filter cloth can be attached for example by means of the clamping ring and/or of the integrated attachment ring in the first and/or second attachment space by means of clamping or jamming for example.

In a particularly important embodiment for practical use, the attachment web is a weld bolt which is welded to the drum jacket and/or to the drum base and/or to the drum lid and/or the attachment web is an attachment bolt and is screwed to the drum jacket and/or to the drum base and/or to the drum lid and/or the attachment bolt is riveted to the drum jacket and/or to the drum base and/or to the drum lid.

This can, for example, be accomplished in that bores are introduced into the centrifuge drum at the corresponding points where such attachment bolts are provided, into which the attachment bolts are then screwed, riveted or welded in a manner known per se.

In a very important example for practical use the weld bolts are welded directly to the corresponding points on the drum jacket and/or on the drum base and/or on the drum lid, without bores having to be introduced into the centrifuge drum at these points beforehand.

In a special case, instead of individual attachment bolts, the attachment web can also be a blocking web extending in the circumferential direction without interruption which can likewise be attached according to one of the previously described methods, in particular by means of direct welding onto a surface in the inside of the centrifuge drum.

The filter medium itself is a filter cloth for example, preferably a textile filter cloth, in particular a filter cloth made of plastic, especially a filter cloth made of polypropylene and/or a filter cloth made of metal and/or a filter cloth made of a composite material, especially of a carbon composite material and/or a filter cloth which is also made from another suitable material.

In this connection the attachment device is preferably designed in such as way that the filter cloth is attachable by means of the attachment device using a clamping ring. The filter cloth can in particular be equipped with a hemstitched seam for the insertion of a clamping ring, preferably of a quick clamping ring as is well known from the prior art as described in the introduction to this specification.

The attachment device can also be designed such that the filter cloth with an integrated attachment ring, especially a filter cloth with a welded attachment ring, preferably with an integrated and/or welded attachment ring with rectangular cross-section, can be attached by means of the attachment device.

In general terms it is to be expressly stressed that all attachment methods known per se and the associated filter mediums or filter cloths which are suitable from the prior art for the attachment in a groove and which have already partly been described in detail in the introduction to this specification, can also be used advantageously without any kind of modification in a centrifuge drum in accordance with the invention.

In this connection a centrifuge drum in accordance with the invention can basically be used advantageously in any kind of centrifuge. For this reason the invention further relates to a centrifuge, in particular to a vertical or horizontally journalled centrifuge, to a continuously or discontinuously operating centrifuge, especially a tube centrifuge, a peeler centrifuge, a decanter centrifuge, a sliding discharge centrifuge, a one stage or multi-stage pusher centrifuge, a double pusher centrifuge or oscillating centrifuge with a centrifuge drum in accordance with the present invention.

The invention will be explained more closely in the following with the help of the drawing which shows:

FIG. 1. A centrifuge drum known from the prior art;

FIG. 2 a first embodiment of a known clamping ring;

FIG. 2a a second embodiment of a known clamping ring;

FIG. 3a a first embodiment of a known centrifuge drum with an attachment groove;

FIG. 3b a second embodiment in accordance with FIG. 3a;

FIG. 3c a third embodiment in accordance with FIG. 3a;

FIG. 3d a fourth embodiment in accordance with FIG. 3a;

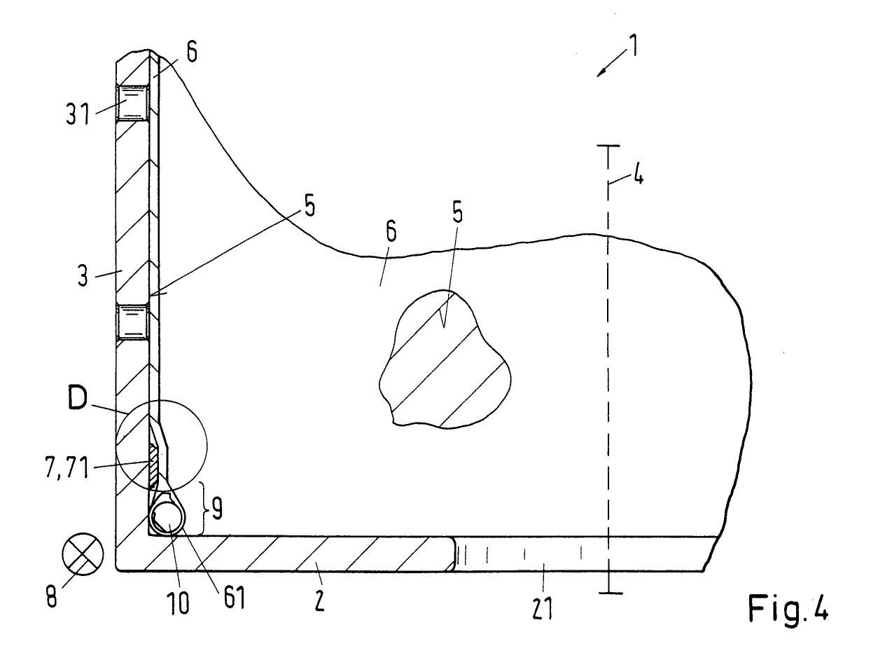

FIG. 4 a first embodiment of a centrifuge drum in accordance with the invention;

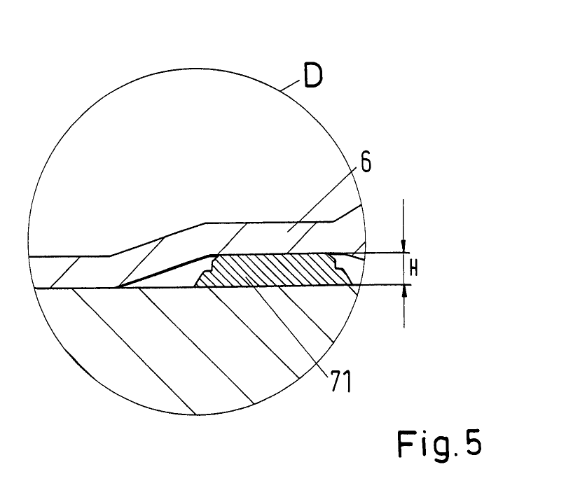

FIG. 5 a detail of an attachment web in accordance with FIG. 4;

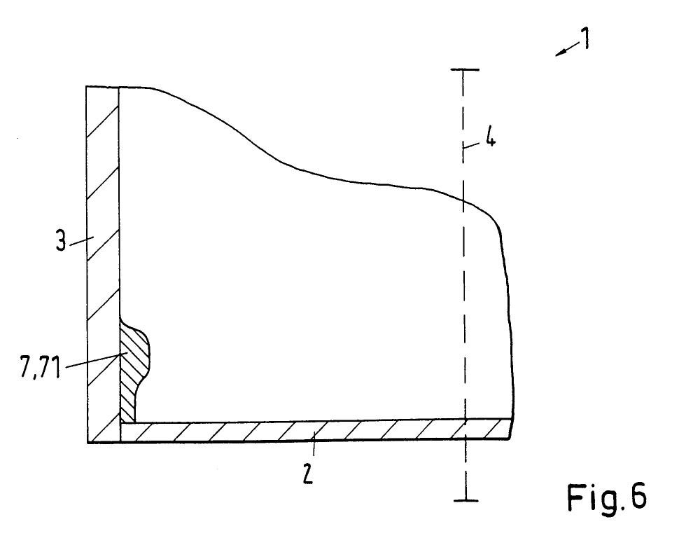

FIG. 6 a two-sided welded weld bolt;

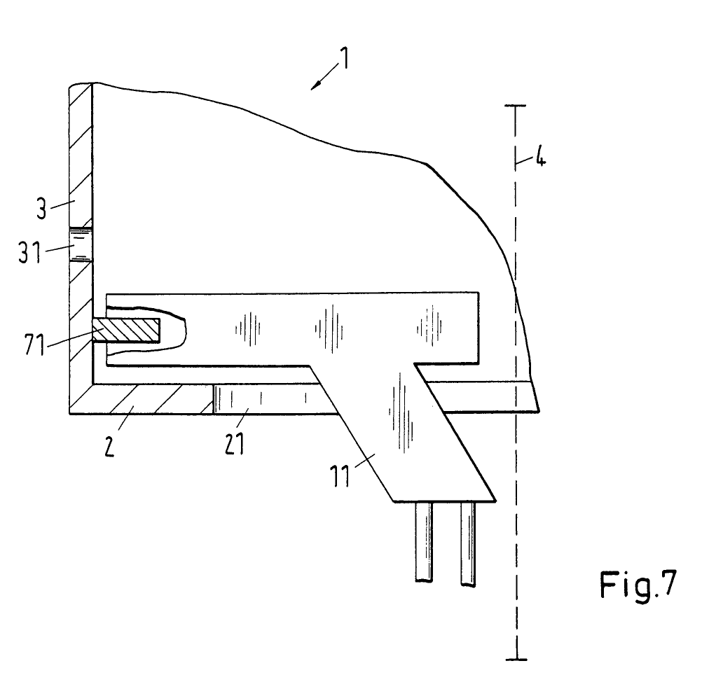

FIG. 7 welding of a weld bolt by means of a welding pistol;

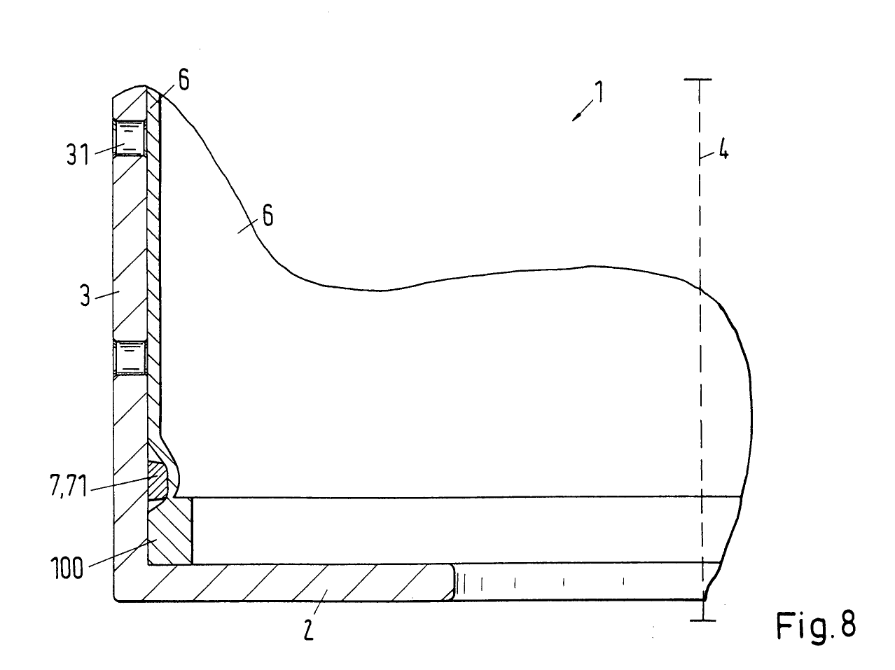

FIG. 8 a second embodiment of a centrifuge drum in accordance with the invention;

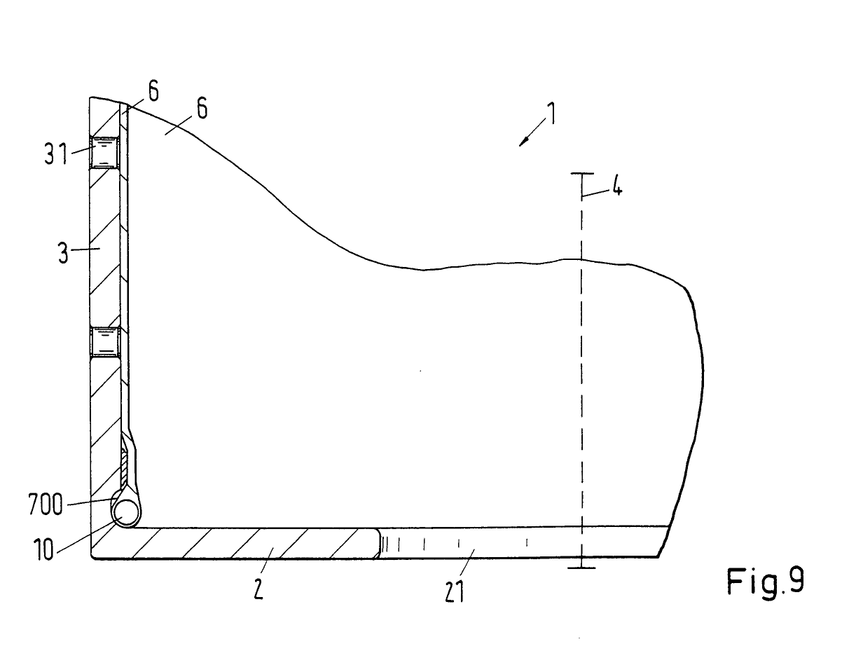

FIG. 9 a first embodiment of a converted centrifuge drum;

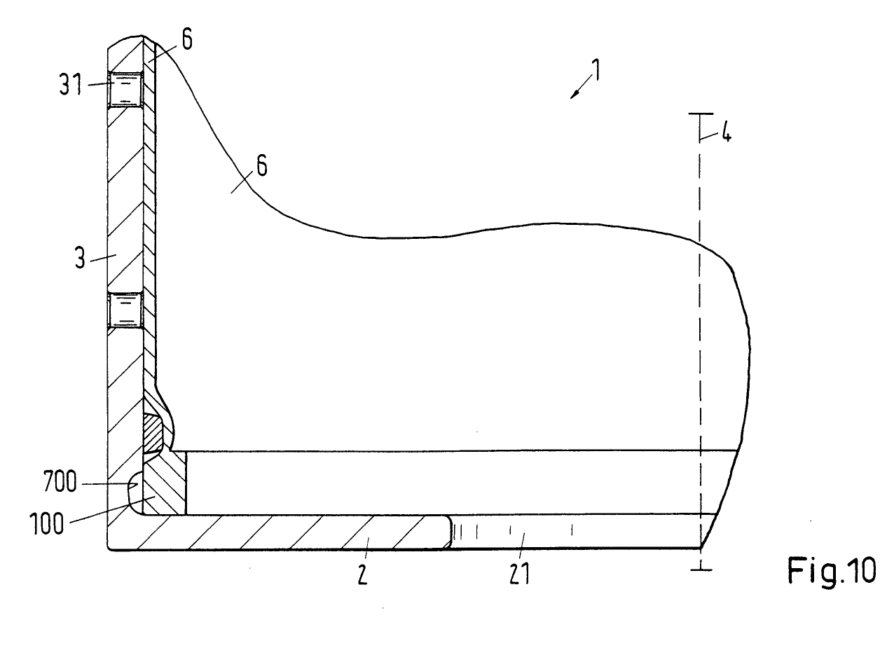

FIG. 10 a second embodiment in accordance with FIG. 9;

As has already been mentioned, FIGS. 1 to 3d illustrate the prior art and have already been explained in detail in the introduction to this specification, so that a further discussion can be omitted here.

FIG. 4 shows in section, in a schematic illustration, a part of a first embodiment of a centrifuge drum in accordance with the invention which will be designated as a whole with the reference numeral 1 in the following. The reference numerals used in FIGS. 4 to 10 do not have an apostrophe since these figures relate to embodiments of the present invention. As already mentioned above, only the reference numerals of FIG. 1 to FIG. 3d have an apostrophe since these relate to the known prior art.

In the centrifuge drum in accordance with the invention in accordance with FIG. 4 a filter cloth 6 is attached by means of a clamping ring 10 into the centrifuge drum 1 in a second attachment space 9 formed in the peripheral direction 8 by a plurality of weld bolts 71 and the drum lid 2.

At the diametrically opposite side to the centrifuge lid 2 is located a drum base, not illustrated in FIG. 4, which likewise forms a first attachment space with a plurality of weld bolts 71, in which the other end of the cylindrically formed filter cloth 6 is likewise fixed with a quick clamping ring 10.

The centrifuge drum 1 includes in a manner known per se a drum jacket 3 with drain apertures 31 through which the centrifuged off liquid phase can be drained out of the centrifuge drum 1 and the drum lid 2 through which, for example through the aperture 21, a suspension which is to be dehydrated can be introduced. Furthermore, as already mentioned the centrifuge drum 1 is formed by a drum base, which is not illustrated for reasons of clarity, which is coupled with a likewise not illustrated rotary drive for the driving of the centrifuge drum 1.

The drum jacket 3 extends in a cylinder shape along the longitudinal axis 4 of the centrifuge drum 1, and the drum lid 2 and the drum base are arranged perpendicular to the longitudinal axis 4 lying diametrically opposite on the drum jacket 3 and thus form the two end surfaces of the cylindrical centrifuge drum 1. A filter medium 6, in the present case a textile filter cloth 6 is provided at an inner peripheral surface 5 of the centrifuge drum 1 and is attached at both ends of the centrifuge drum 1 by means of a clamping ring 10.

In addition, as seen in relation to the axial longitudinal direction, a peripheral hemmed seam 61 is provided at both ends of the filter cloth 6 in the peripheral direction 8, into which the clamping ring 10 is introduced prior to the installation of the filter cloth 6 in the centrifuge drum 1.

For installation the filter cloth 6 is then placed on the inner peripheral surface 5 of the centrifuge drum 1, the hollow seam 61 with the clamping ring 10 is laid into the first attachment space and/or into the second attachment space and the clamping ring 10 is then fixed, for example by means of a clamping device, which is known per se and which has already been explained in the discussion of the prior art.

Thus FIG. 4 impressively illustrates that with the present invention a groove for attaching the filter cloth 6 can be omitted since the function of the groove known from the prior art is replaced by the cooperation of the attachment webs 7, 71 with an adjacent drum lid 2 and/or the drum base and/or the drum jacket 3.

FIG. 5 shows the detail D in accordance with FIG. 4 in a larger scale illustration. The weld bolt 71 is welded onto the drum jacket 3 of the centrifuge drum 1 using a welding pistol still to be described in FIG. 7. The weld bolt 71, which is, for example, originally approximately 12 mm to 20 mm long, is ground flat after the welding on, as can be seen clearly from FIG. 5, so that the filter cloth 6 can be lain over the weld bolt 7 without suffering damage and also is not damaged even under a raised pressure load in the operating state of the centrifuge. The weld bolt 71 can be ground off to a height H in this arrangement, which in the present very special example of FIG. 4 and FIG. 5 amounts to approximately 2 mm to 3 mm.

In FIG. 6 a weld bolt welded at two sides is illustrated which is welded on the drum lid 2 and on the drum jacket 3 at the same time, whereby an even higher stability of the connection of the weld bolt 71 with the centrifuge drum 1 can be achieved in particular for high loads in the operating state. In other respects, in the example of FIG. 6, no filter cloth 6 has as yet been inserted into the centrifuge drum 1.

The welding of a weld bolt 71 with the drum jacket 3 by means of a welding pistol 11 is schematically illustrated in FIG. 7. The welding pistol 11 and this type of welding of weld bolts 71 on a metallic substrate is known per se and is very easy to handle. The weld bolt 71 is inserted into the welding pistol 11 for example, or the welding pistol 11 has a magazine with a store of welding bolts 71, and thereafter the welding pistol 11 is attached at a desired place on the drum base, or on the drum lid 2 or on the drum jacket 3. When the weld bolt 71 is placed on the drum wall in this way, the welding pistol 11 is activated and the weld bolt 71 is fixedly welded to the drum wall. In this connection for carrying out the welding procedure the welding pistol 11 can, for example, be comfortably inserted through the aperture 21 in the drum lid 2 into the centrifuge drum 1, so that old centrifuge drums with grooves can be comfortably retrofitted in the centrifuge and indeed in the installed state.

A second embodiment of a centrifuge drum 1 in accordance with the invention is illustrated schematically in FIG. 8, which essentially only differs from the example of FIG. 4 in that the attachment webs 7, 71, in other words the weld bolts 71 for example, are arranged in such a way that a filter cloth 6 with an integrated attachment ring 100 with rectangular cross-section, which in the present example is an attachment ring 100 welded to the filter cloth 6, can be reliably fixed in the centrifuge drum 1.

Finally, FIG. 9 and FIG. 10 each show an embodiment of retrofitted centrifuge drums 1 in a schematic manner which were originally still provided with grooves 700.

In this connection the original centrifuge drums in accordance with FIG. 9 and FIG. 10 were completely identical prior to the conversion. However, the centrifuge drum 1 according to FIG. 9 in accordance with the invention was converted in such a way that a filter cloth with a quick clamping ring 10 can now be attached in the centrifuge drum in accordance with the invention, whereas the centrifuge drum according to FIG. 10 was converted in such a way that from now on a filter cloth 6 with an integrated attachment ring 100 can be installed in the centrifuge drum 1.

It goes without saying that the features of the particularly preferred design variants of the centrifuge drum in accordance with the invention, previously described by way of example, can also be combined in an advantageous manner depending on the requirements and can in principle be used in all types of centrifuge. In particular a centrifuge drum in accordance with the invention can be advantageously used in a vertical or horizontally journalled centrifuge, in a continuously or discontinuously working centrifuge, especially in a tube centrifuge, a peeler centrifuge, a decanter centrifuge, a sliding discharge centrifuge, in a one stage or multi-stage pusher centrifuge, a double pusher centrifuge or in an oscillating centrifuge.

1. A centrifuge drum for a centrifuge for the separation of a mixture into a solid material cake and into a liquid phase, including a drum lid (2) forming the centrifuge drum, a drum base and a drum jacket (3), wherein the drum jacket (3) extends along a longitudinal axis (4) of the centrifuge drum and the drum lid (2) and the drum base are arranged on the drum jacket (3) perpendicular to the longitudinal axis (4) and opposite to one another, said centrifuge drum being rotatably arranged about the longitudinal axis (4) in the centrifuge in the installed state and being rotatable in the operating state at a pre-determinable speed of rotation about the longitudinal axis (4) by means of a drive and with a filter medium (6) being provided at an inner peripheral surface (5) of the centrifuge drum, wherein an attachment device (7) is provided at the inner peripheral surface (5) of the centrifuge drum, at least section-wise, for the fixing of the filter medium (6), characterised in that the attachment device (7) has the form of an attachment web (7, 71) protruding radially into the centrifuge drum in the direction towards the longitudinal axis (4) of the centrifuge drum and extends on the inner peripheral surface (5) along a peripheral direction (8) of the centrifuge drum around the longitudinal axis (4).

2. A centrifuge drum in accordance with claim 1, wherein the attachment device (7) extends along the peripheral direction (8) at a pre-determinable distance from the drum base in such a manner that a first attachment space extending in the peripheral direction (8) is formed between the drum base and the attachment device (7) for the fixing of the filter medium (6).

3. A centrifuge drum in accordance with claim 1, wherein the attachment device (7) extends along the peripheral direction (8) at a pre-determinable spacing from the drum lid (2) in such a way that a second annular attachment space (9) extending in the peripheral direction (8) is formed between the drum lid (2) and the attachment device (7) for the attachment of the filter medium (6).

4. A centrifuge drum in accordance with claim 1 wherein a plurality of attachment webs (7, 71) is provided which are preferably formed as blocking pins (71).

5. A centrifuge drum in accordance with claim 1 wherein the attachment web (7, 71) is a weld bolt (71) and is welded to the drum jacket (3) and/or to the drum base and/or to the drum cover (2) and/or wherein the attachment web (7, 71) is an attachment bolt (71) and is screwed to the drum jacket (3) and/or to the drum base and/or to the drum lid (2) and/or is riveted to the drum jacket (3) and/or to the drum base and/or to the drum lid (2).

6. A centrifuge drum in accordance with claim 1 wherein the attachment web (7, 71) is a blocking web (7) extending in the circumferential direction (8) without interruption.

7. A centrifuge drum in accordance with claim 1 wherein the filter medium (6) is a filter cloth (6), preferably a textile filter cloth (6), in particular a filter cloth (6) made of plastic, especially a filter cloth (6) made of polypropylene and/or a filter cloth (6) made of metal and/or a filter cloth (6) made of a composite material, especially of a carbon composite material and/or a filter cloth (6) of another suitable material.

8. A centrifuge drum in accordance with claim 1 wherein the attachment device (7) is designed in such a way that the filter cloth (6) is attachable by means of the attachment device (7) using a clamping ring (10).

9. A centrifuge drum in accordance with claim 1 wherein the attachment device (7) is designed in such a way that the filter cloth (6) with an integrated attachment ring (100) can be attached by the attachment device, especially a filter cloth (6) with a welded attachment ring (100), preferably with an integrated and/or welded attachment ring (100) with rectangular cross-section.

10. A centrifuge, in particular a vertical or horizontally journalled centrifuge, a continuously or discontinuously working centrifuge, especially a tube centrifuge, a peeler centrifuge, a decanter centrifuge, a sliding discharge centrifuge, a one stage or multi-stage pusher centrifuge, a double pusher centrifuge or an oscillating centrifuge with a centrifuge drum (1) in accordance with claim 1.
